(19) United States
(12) Patent Application Publication
(10) Pub. No.: US 2012/0296729 A1
(43) Pub. Date: Nov. 22, 2012

(54) Card for Locals

(76) Inventor: Robert Dietz, San Diego, CA (US)

(21) Appl. No.: 13/108,911

(22) Filed: May 16, 2011

(51) Int. Cl. G06Q 30/00

(52) U.S. Cl. 705/14.35

(57) ABSTRACT

Preferred embodiments of a combination group couponing and member-only product discounting system and methods.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of Invention

The invention relates generally to group couponing and members-only product discounting systems.

2. Background

Consumers purchase various types of goods or services (herein after “products”). Frequently, the purchase price for such products is dependent upon the quantity of products purchased. For instance the bulk price per unit for a product is typically less than the price per individual unit (or smaller bulk). With any price differential between two identical products, it is most commonly desirable for a consumer to purchase the product at the discounted price. Accordingly, many products are purchased in bulk rather than individually.

Circumstances arise, however, where it is impractical for a consumer to purchase a product in bulk and, instead, must purchase the product individually. For example: a purchaser may not possess sufficient resources to purchase more than one product unit (e.g., a vehicle) and, therefore, must only purchase an individual unit at the higher price; certain products are perishable (e.g., perishable food stuffs) and, as a result, are better suited to individual purchase since a consumer may not be capable of consuming the product in bulk prior to perishment; and the product purchased (e.g., an MP3 or digital movie) may be susceptible to multiple uses without depletion so that a bulk product purchase is redundant. Accordingly, there is a need for systems and methods for purchasing an individual product at a discounted bulk price.

One proposed solution to the identified need is group couponing, which is embodied by www.groupon.com and www.livingsocial.com, among other group couponing websites. In general, group couponing is the practice of conditionally offering a product to a group via a broker (e.g., Groupon, Inc.) at a bulk per unit price wherein: if members of the group collectively purchase the product in bulk, then the offer is accepted and the bulk product is distributed amongst the purchasing members of the group, or else the offer is not accepted and revoked by the offeror. Although group couponing may be capable of resulting in individual product units being sold at a discounted price, group couponing is not entirely satisfactory of said need.

One unsatisfactory aspect of group couponing is that the offeror must pay fees or commissions to the broker to present the offer to the group or whenever the offer is accepted by the group, which broker fees result in product pricing that is not as low as it otherwise could be. Another unsatisfactory aspect of group couponing is that the broker typically presents offers to all members of the group regardless of whether or not members of the group are interested in the particular offer, which presentation correspondingly wastes time and resources of the offeror and group members. Yet still another unsatisfactory aspect of the group couponing is that different offerors make different offers for different products or nonuniform offers for identical or similar products so that group members are continually inundated with offers, which inundation can result in either (a) wasted time and resources of the user or (b) desirable offers to the user being lost, overlooked, or ignored among the other offers. In view of the potentially unsatisfactory aspects of group couponing, there remains a need for systems and methods for purchasing an individual product at a discounted bulk rate.

Another proposed solution to the above identified need is a members-only product discounting systems, embodied by www.thelocalsonlycard.com, www.mylocalscard.com, www.santabarbaralocalcard.com, www.vipclubcard.com, and Costco (see www.costco.com). In general, members-only product discounting systems are of two types: (1) bulk price per product unit offers to the membership wherein the bulk is purchased by the membership over a period of time through repeat purchases (“loyalty systems”) (see e.g., Costco); or (2) the number of participating discount offerors is restricted within each industry or product type with the expectation that, in view of said restriction, the membership will be more likely to accept the offer in a sufficient number to purchase the bulk (“restricted offeror system”) (see, e.g., www.thelocalsonlycard.com). Although members-only product discounting may be capable of resulting in individual product units being sold at a bulk per unit price, members-only product discounting is also not entirely satisfactory of the need for systems and methods for purchasing an individual product unit at a bulk per unit price. Specifically, among other things: loyalty systems are too restrictive in that the membership may only buy discounted products of a single offeror; restricted offer systems are unsatisfactory in that, although restricted in number, different offerors make different offers for different products or nonuniform offers for identical or similar products so that group members are continually inundated with offers, which inundation can result in either (a) wasted time and resources of the user or (b) desirable offers to the user being lost, overlooked, or ignored among the other offers. In view of the potentially unsatisfactory aspects of members-only product discounting systems, there remains a need for systems and methods for purchasing an individual product at the discounted bulk rate.

### SUMMARY OF THE INVENTION

In view of the foregoing, it is an object of this application to disclose systems and methods for purchasing an individual product at a discounted bulk rate that avoid (a) inundating purchaser's with offers and (b) presenting irrelevant offers (i.e., of no interest to purchasers). To meet this objective, this disclosure generally describes preferred embodiments of a combination group couponing and member-only product discounting system and methods wherein: a population of more than one individual that is interested in a product is identified and incorporated into a membership; a population of more than one offeror with a bulk of the particular product is identified; the membership is introduced to the population of offerors; one the offerors in the population of more than one offeror is provided with a limited time-period to exclusively offer the product to the membership at a discounted bulk rate; and, upon expiration of the limited time-period, another one of the offerors in the population of more than one offeror is provided with another, but equally limited, time-period to exclusively make the same offer to the membership.

### BRIEF DESCRIPTION OF THE FIGURES

Not applicable.

### DETAILED DESCRIPTION OF PREFERRED EMBODIMENTS

This disclosure describes preferred embodiments of a combination group couponing and member-only product discounting system and methods wherein: a population of more than one individual that is interested in a product is identified and incorporated into a membership; a population of more than one offeror with a bulk of the particular product is identified; the membership is introduced to the population of offerors; one the offerors in the population of more than one offeror is provided with a limited time-period to exclusively offer the product to the membership at a discounted bulk rate; and, upon expiration of the limited time-period, another one of the offerors in the population of more than one offeror is provided with another but equally limited time-period to exclusively make the same offer to the membership.

In a first aspect of the disclosed system, entities may gather into a population that is interested in purchasing a particular product. For instance, entities may gather into a population that is desirous of consuming alcoholic beverages. It should be noted that the gathering of the entities need not be physical in nature and may, instead, be a gathering of information. In one non limiting embodiment, the gathering is accomplished by a web application defined by computer code on computer readable memory wherein the computer code is configured to present a user interface to an entity, receive inputs of information identifying the entity, receive inputs of information identifying a product of interest to the entity, populate a database with at least an indication of the identifying information of the entity in association with at least an indication of the identifying information of the product so that the information may be matched with other entities with a like interest in the product. Those of skill in the art will know well the manner by which entities may be gathered into a population that is interested in a particular product. In an optional embodiment each member may be required to pay membership dues for inclusion within the population. In yet another optional embodiment, subpopulations may be divided from the population based on geography (e.g., by city or county).

In a second aspect of the disclosed system, the population may be incorporated into a membership. Incorporation into a membership may be accomplished by providing a unique credential to each member in the population. The unique credential may be, for example, a card or code. The credential may be tangible or intangible. In an optional embodiment each member may be required to pay continued membership dues for continued issuance of the membership credential.

In a third aspect of the disclosed system, a population of offerors with a bulk of the product of interest to the membership population may be identified. In one embodiment the population may be identified by (1) surveying the inventory of products of a plurality of entities wherein all entities with a bulk of the product are placed within the population (2) or determining a class of entities likely to possess a bulk of the product wherein so classed entities are placed within the population. Continuing the example from above, bars and restaurants are likely to have a bulk of alcoholic beverages and so the population of offerors may be all bars and restaurants. As with the population of members the population may be gathered or identified by a web application configured to search the internet or other directory for offeror entities of a particular classification likely to possess a bulk of the product or for offeror entities with a bulk of the product in their inventory, wherein at least an indication of an offeror entity is populated to a database in association with the product so that the relevant population may be determined. As with the membership population, the offeror population may be divided into subpopulations based on geography.

In a fourth aspect of the invention, the membership population may be introduced to the offeror population. The introduction may be in the form of each offeror being informed that a population exists that is interested in a product that the offeror possesses. Continuing the above example a bar or restaurant population may be informed a population of entities is interested in consuming alcoholic beverages. Those of skill in the art will know well the ways by which a membership population may be introduced to a population of offerors. In a preferable embodiment, membership subpopulations are introduced to offeror subpopulations of like geography.

In a fifth aspect of the invention, one entity in the population of offerors is provided with a limited time-period to exclusively offer the product to the membership population at a discounted bulk rate and, upon expiration of the limited time-period, another one of the entities in the population offerors is provided with a consecutive but equally limited time-period to exclusively make the same offer to the membership. Additional entities may also be provided with further consecutive and equally limited time-periods to exclusively make the same offer. Still continuing the example from above, a first bar or restaurant in a population of fifty-two bars or restaurants may be provided with a week within which the bar/restaurant may offer to the membership population a product discount of “buy one drink and get another drink for a fifty percent” discount and, upon the expiration of the week period, a second bar offers the same discount for the following week wherein the offers continue from until each of the 52 bars/restaurants time periods expire (e.g., for 1 year). The offer order may be determined randomly or by some structured algorithm (e.g., based on date of inclusion in the offeror population). In one embodiment offer order is determined by computer program on computer readable memory. In optional embodiment, the entities may be required to pay a fee to a broker before making an offer to the membership.

In a sixth aspect of the present disclosure, the offer may be communicated to each member of the membership population. Communication may be accomplished by any known method of communication but email communication is preferable. In an optional embodiment, the offer is communicated to the membership population at the start of each limited time-period and the communication may preferably be automatically generated. Those of skill in the art will know well methods for communicating offers to a population.

In a seventh aspect of the present disclosure, the offer may be accepted by any one of the membership population. Acceptance may be made by referencing the offer and presenting membership credentials. Suitably, the presentation of credentials and referencing of the offer may be done at the point of sale or online. Continuing the example above, a member of the membership population may enter a bar or restaurant and present a membership card to accept the offered discount. For online acceptance the offer may be associated with a code and a web application may be provided to an accepting member of the membership population, the web application preferably being configured to receive an input of the offer code and an input of the membership credentials.

In a final aspect of the disclosure, the product may be provided to the accepting member of the membership population.

The foregoing description of implementations has been presented for purposes of illustration and description. It is not exhaustive and does not limit the claimed inventions to the precise form disclosed. Modifications and variations are possible in light of the above description or may be acquired from practicing the invention. For example, the above disclosure may apply to clothing retailers offering discounts of any kind for clothing and apparel (including shoes), art dealers offering art, and restaurants offering food deals, or any other offeror offering a good or service. The claims and their equivalents define the scope of the invention. It should be apparent that further numerous structural modifications and adaptations may be resorted to without departing from the scope and fair meaning of the present invention as set forth hereinabove and as described herein below by the claims.

I claim:

1. A group discount system:
a first population of more than one entity that is interested in a product;
a second population of more than one entity with a bulk of the product;
wherein the first population is introduced to the second population;
wherein only one of the entities in the second population offers for a limited time-period the product at a discounted rate to the first population; and,
wherein upon expiration of the limited time-period, only another one of the entities in the second population offers for another but equally limited time-period the product at a discounted rate to the first population.
